(19) United States
(12) Patent Application Publication
(10) Pub. No.: US 2005/0193841 A1
(43) Pub. Date: Sep. 8, 2005

(54) Starter motor for vehicle

(75) Inventors: Sang-Hyuk Ahn, Kyongju-si (KR); Jung-Yeol Lee, Dong-gu (KR); Soo-Sin Kim, Kyongju-si (KR); Jae-Chul Lee, Kyongju-si (KR); Byung-Chan Seo, Kyongju-si (KR); Jong-in Lee, Kyongju-si (KR)

Correspondence Address: R. Neil Sudol, 714 Colorado Avenue, Bridgeport, CT, 06605-1601, US

(73) Assignee: Valeo Electrical Systems Korea Limited, Kyongju-si (KR)

(21) Appl. No.: 11/054,346

(22) Filed: Feb. 9, 2005

(30) Foreign Application Priority Data
Feb. 26, 2004 (KR) 10-2004-0012947

(51) Int. Cl. F02N 1/00

(52) U.S. Cl. 74/7 R

(57) ABSTRACT

The starter motor for a vehicle is capable of achieving a minimum and optimum size of a magnet switch and a starter motor in such a manner that a lever ratio R and an air gap A are improved in a range satisfying a designated moving distance P of a pinion. There is provided an improved starter motor for a vehicle characterized in that an air gap A is set below 8 mm, and a lever ratio R is adjusted above 1.67, whereby a moving distance P of the pinion is about 13 mm. In addition, there is provided an improved starter motor for a vehicle characterized in that the multiplication of air gap A and lever ratio R is below 14 mm, whereby a moving distance P of the pinion is about 13 mm.

### BACKGROUND OF THE INVENTION

1. Field of the Invention

The present invention relates to a starter motor for a vehicle, and in particular to a starter motor for a vehicle capable of achieving a smaller size system in such a manner that a lever adapted to drive an output shaft pinion of a starter motor and a magnet switch adapted to drive the lever are improved.

2. Description of the Background Art

As shown in FIG. 1, a starter motor for a vehicle generally includes a front bracket 12 and a rear bracket 13 assembled to a cylindrical yoke housing 1, a pole 11 provided in the interior of the cylindrical yoke housing 1, an armature assembly 10 installed at a center of the cylindrical yoke housing 1, a brush holder assembly 60 for supplying power to the armature assembly 10, a lever 50 that is adapted to transfer a rotational force generated by the armature assembly 10 to a pinion 31 installed at a front end of a shaft 30 through an over running clutch 20 for thereby forwardly and backwardly moving the pinion 31, and a magnet switch 40 adapted to drive the lever 50.

When the brush holder assembly 60 supplies electric power, the armature assembly 10 is rotated. The rotational force becomes a starter driving force as the pinion 31 of the output shaft forwardly moving by the operation of the lever 50 is engaged with a ring gear (not shown) of the engine.

At this time, an upper end of the lever 50 which makes the pinion 31 move forwardly is connected with a plunger 41 of the magnet switch 40, so that the whole size and performance of the solenoid are determined based on an air gap A of the plunger 41, and a lever ratio R of the lever 50 rotating about a hinge point 51. As used herein, the term “air gap A” represents a moving distance of the plunger 41 of the magnet switch 40. As used herein, the term “lever ratio R” represents the ratio of a lower end L2 with respect to the upper end L1 from the hinge point 51 in the lever 50.

As shown in FIG. 1, in the conventional starter motor, assuming that the air gap A is 9.9 mm, and the lever ratio R is 1.76, when the moving distance P of the pinion satisfies 13 mm, the gap G1 between the lever upper end and the plunger is 1.75 mm, and the gap G2 of the lever hinge point is 0 mm, and the gap G3 between the lever lower end and the over running clutch is 2.5 mm.

However, in the conventional starter motor, since the air gap A is relatively big, the above values G1, G2 and G3 are needed. Therefore, the whole size of the solenoid gets increased.

Therefore the conventional starter motor in FIG. 1 is basically designed for both small- and meddle-sized vehicles in one model. Therefore, the conventional starter motor is not well adapted to the minimum and optimum design conditions for only small-sized vehicles.

### SUMMARY OF THE INVENTION

Accordingly, it is an object of the present invention to overcome the problems encountered in the conventional art.

It is main object of the present invention to provide a starter motor for a vehicle capable of achieving a minimum and optimum size of a magnet switch and a starter motor in such a manner that a lever ratio R and an air gap A are improved in a range satisfying a designated moving distance P of a pinion.

To achieve the above objects, a starter motor for a vehicle having a front bracket and a rear bracket assembled to a cylindrical yoke housing, a stator assembly provided in the interior of the cylindrical yoke housing, an armature assembly installed at a center of the cylindrical yoke housing, a brush holder assembly for supplying power to the armature assembly, a lever that is adapted to transfer a rotational force generated by the armature assembly to a pinion installed at a front end of a shaft through an over running clutch for thereby forwardly and backwardly moving the pinion, and a magnet switch adapted to drive the lever, is characterized in that an air gap A is set below 8 mm, and a lever ratio R is adjusted above 1.67, whereby a moving distance P of the pinion is about 13 mm.

A magnet switch adapted to drive the lever, is also characterized in that the multiplication of air gap A and lever ratio R is below 14 mm, for 13 mm of a moving distance P of the pinion.

### BRIEF DESCRIPTION OF THE DRAWINGS

The present invention will become better understood with reference to the accompanying drawings which are given only by way of illustration and thus are not limitative of the present invention, wherein;

FIG. 1 is a cross sectional view illustrating a conventional starter motor for a vehicle; and

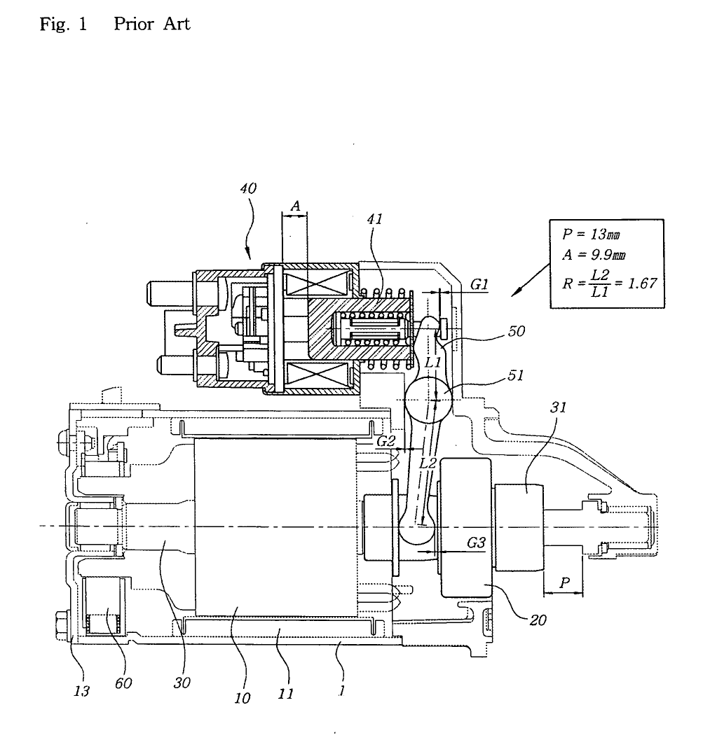

FIG. 2 is a cross sectional view illustrating a starter motor for a vehicle according to the present invention.

### DETAILED DESCRIPTION OF THE PREFERRED EMBODIMENTS

The preferred embodiments of the present invention will be described with reference to the accompanying drawings.

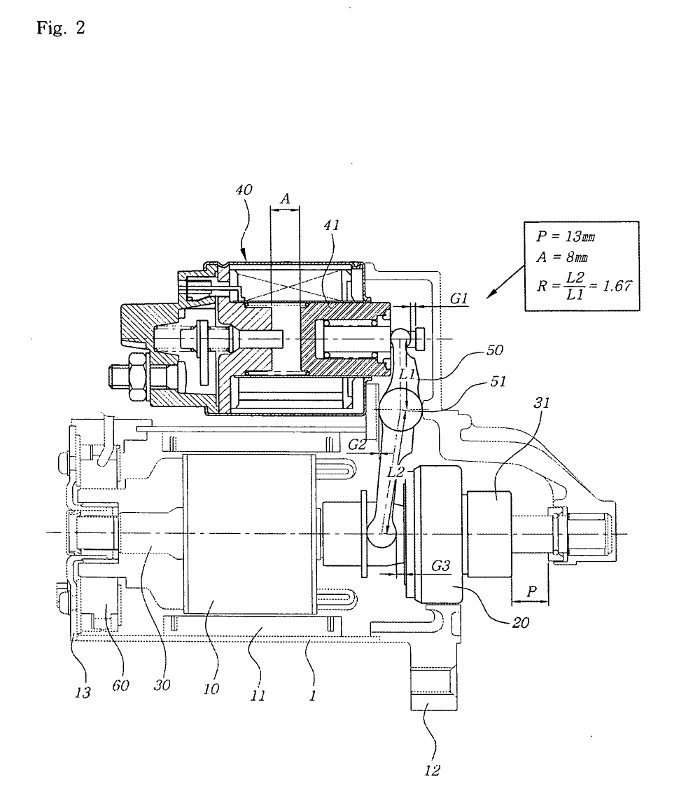

FIG. 2 is a cross sectional view illustrating a starter motor for a vehicle according to the present invention. As shown therein, in the same construction as the conventional starter motor, the starter motor for a vehicle according to the present invention includes a front bracket 12 and a rear bracket 13 assembled to a cylindrical yoke housing 1, a pole 11 provided in the interior of the cylindrical yoke housing 1, an armature assembly 10 installed at a center of the cylindrical yoke housing 1, a brush holder assembly 60 for supplying power to the armature assembly 10, a lever 50 that is adapted to transfer a rotational force generated by the armature assembly 10 to a pinion 31 installed at a front end of a shaft 30 through an over running clutch 20 for thereby forwardly and backwardly moving the pinion 31, and a magnet switch 40 adapted to drive the lever 50.

In the present invention, an air gap A is set below 8 mm, and a lever ratio R is adjusted above 1.67, whereby a moving distance P of the pinion 31 is about 13 mm.

The moving distance P of the pinion 31 is assumed to be 13 mm for the reasons that it corresponds to the moving distance for an engagement with a ring gear (not shown) of the engine. P is previously set based on the models of the vehicles.

As shown in FIG. 2, the air gap A represents a certain space in which the plunger 41 of the solenoid forwardly and backwardly moves. Here, the upper and lower ends of the lever 50 are formed in a rounded shape for a smooth operation. The length of the upper end L1 is from the center of the hinge point 51 to the circular center of the upper end of the lever, and the length of the lower end L2 is from the center of the hinge point 51 to the circular center of the lower end of the lever.

The value G1 represents the gap between the hook of the plunger 41 and the upper end L1 of the lever 50, the value G2 represents the gap of the hinge point, and the value G3 represents the gap between the lower end L2 of the lever 50 and the over running clutch 20.

In the present invention, the air gap A is set 8 mm, and the lever ratio R is set 1.67. The multiplication of the above two values become a moving distance P of the pinion 31, namely, 8 mm×1.67=13.36 mm. Therefore, it is good enough to have such a moving distance of 13 mm of the pinion. The remaining value of 0.36 mm is adapted for the gap of G1 or G3.

In the present invention, it is possible to decrease the diameter of the solenoid by 15%, and the weight of the same can be decreased by about 50%.

In the conventional starter motor for a vehicle, the weight of the solenoid of the magnet switch is about 550 g˜650 g. However, in the present invention, the weight of the solenoid is about 300 g.

In another embodiment of the present invention, the construction may be embodied in the following methods.

Namely, in the present invention, the multiplication of air gap A and lever ratio R is below 14 mm, whereby a moving distance P of the pinion is about 13 mm.

The multiplication of air gap A and lever ratio R is the moving distance P of the pinion. Assuming that the moving distance P of the pinion is 14 mm and the air gap A is below 8 mm, the lever ratio R is increased as low as the decreased air gap A. Assuming that the moving distance P of the pinion is 14 mm and the lever ratio R is above 1.67, the air gap A is decreased as high as the increased lever ratio R.

The above values are variable, so that the above values are not limited thereto.

As described above, the present invention can be best adapted to a vehicle engine having a moving distance 13 mm of pinion because the lever ratio and air gap are set 1.67 and 8 mm, respectively, in a range that a moving distance of pinion is set 13 mm.

Therefore, the starter motor for a vehicle according to the present invention has advantages of providing a light and minimized size starter motor as compared with the conventional starter motor designed for both larger and smaller engines.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A starter motor for a vehicle having a front bracket and a rear bracket assembled to a cylindrical yoke housing, a stator assembly provided in the interior of the cylindrical yoke housing, an armature assembly installed at a center of the cylindrical yoke housing, a brush holder assembly for supplying power to the armature assembly, a lever that is adapted to transfer a rotational force generated by the armature assembly to a pinion installed at a front end of a shaft through an over running clutch for thereby forwardly and backwardly moving the pinion, and a magnet switch adapted to drive the lever, characterized in that an air gap A is set below 8 mm, and a lever ratio R is adjusted above 1.67, whereby a moving distance P of the pinion is about 13 mm.

2. A starter motor for a vehicle having a front bracket and a rear bracket assembled to a cylindrical yoke housing, a stator assembly provided in the interior of the cylindrical yoke housing, an armature assembly installed at a center of the cylindrical yoke housing, a brush holder assembly for supplying power to the armature assembly, a lever that is adapted to transfer a rotational force generated by the armature assembly to a pinion installed at a front end of a shaft through an over running clutch for thereby forwardly and backwardly moving the pinion, and a magnet switch adapted to drive the lever, characterized in that the multiplication of air gap A and lever ratio R is below 14 mm, whereby a moving distance P of the pinion is about 13 mm.
